(19) United States
(12) Patent Application Publication
(10) Pub. No.: US 2010/0192782 A1
(43) Pub. Date: Aug. 5, 2010

(54) COFFEE MACHINE

(75) Inventors: Daniel Blumenauer, Bern (CH); Bernhard Künzler, Dubendorf (CH)

Correspondence Address: PEARNE & GORDON LLP, 1801 EAST 9TH STREET, SUITE 1200, CLEVELAND, OH, 44114-3108, US

(73) Assignee: Schaerer AG, Zuchwil (CH)

(21) Appl. No.: 12/667,706

(22) PCT Filed: Jul. 4, 2008
(86) PCT No.: PCT/EP08/58718

§ 371 Date: Apr. 20, 2010

(30) Foreign Application Priority Data
Jul. 5, 2007 (EP) 07111836.8

(51) Int. Cl. A47J 31/40

(52) U.S. Cl. 99/302 R

(57) ABSTRACT

A coffee machine (1) for dispensing brewed coffee is equipped with a coffee spout (2) beneath which a cup (3) is placeable. The brewed coffee emerging through the coffee spout (2) ends up in the vessel; the operation of the coffee machine and the delivery of coffee are controlled by means of a control unit (4). At least one supply means (5) is associated with the coffee machine (1) for dispensing at least one flavoring agent (6), which supply means are in each case equipped with a container (7) for accommodating a flavoring agent (6) and delivery and metering means (12, 13, 14, 15) for delivering a metered quantity of the flavoring agent (6) from the container into a line (9). This line (9) is provided with a spout (10) which is arranged such that the delivered flavoring agent (6) ends up in the cup (3) positioned beneath the coffee spout (2). With this device an additional special flavor can be admixed with a freshly brewed coffee.

The present invention relates to a coffee machine for dispensing brewed coffee with a coffee spout, under which a vessel, in particular a cup, is placeable, so that brewed coffee emerging through the coffee spout ends up in the vessel, and a control unit, with which the operation of the coffee machine and the dispensing of coffee are controllable.

Coffee machines of this type are known in diverse designs. Known in particular are automatic coffee machines, in which for each coffee to be dispensed coffee powder freshly ground from coffee beans is produced, is conducted to a brewing chamber, in which the coffee to be dispensed is able to be brewed under optimal conditions. Coffee machines of this kind can also be supplemented with devices with which milk in varying consistency is able to be added to the coffee dispensed, whereby milk coffee or caffè latte, cappuccino and caffè macchiato, etc. can also be produced with coffee machines of this kind, in addition to normal coffee and espresso coffee.

Becoming more and more popular are also coffee-based beverages in which additionally a flavoring agent is added to the coffees dispensed from the coffee machine. Particularly suitable flavors in this connection are vanilla, amaretto, hazelnut, caramel, cinnamon, almond or chocolate, for example. These flavoring agents are added by hand to the coffee produced by the coffee machine, and are also mixed by hand.

The object of the present invention now consists in designing a coffee machine in such a way that when selecting a coffee from this coffee machine, in addition to selecting the kind of coffee, it is also possible to select whether an additional flavoring agent should be added to this coffee, so that, if applicable, the coffee dispensed from the coffee machine is already provided with this selected flavoring agent.

This object is achieved according to the invention in that associated with the coffee machine is at least one supply means for dispensing at least one flavoring agent, which supply means is provided in each case with a container for accommodating a flavoring agent as well as conveying and metering means for delivering a metered quantity of the flavoring agent from the container into a line, which line is provided with a spout which is arranged such that the conveyed flavoring agent ends up in the vessel positioned under the coffee spout.

With a coffee machine equipped in this way, the dispensing of additionally flavored coffees becomes possible in the easiest way.

Advantageously, the flavoring agent is of liquid form, and is fillable into the container, which is closable. By using a flavoring agent in liquid form, this agent can be added to the coffee during delivery of the brewed coffee into the cup; an optimal mixing takes place automatically.

An advantageous embodiment of the invention consists in that the conveying and metering means for each supply means comprise a further line, which line comes out into the closable container, which line is connected to a compressed air source, and through which line compressed air is able to be supplied to the closable container in a controlled way, and the line is submerged, by the end opposite the spout, in the liquid flavoring agent filled in the container. This simple construction of the conveying and metering means makes it possible to produce these means cost effectively. Through the use of a compressed air source, the conveying and metering of the flavoring agent to be supplied can be controlled in a simple way.

Advantageously, the compressed air source is made up of an air pump which is able to be activated and deactivated via the control unit. The coffee machine can thereby be operated autonomously (without external compressed air source).

Another advantageous embodiment of the invention consists in that a plurality of supply means are associated with the coffee machine, whereby it becomes possible to select from among various flavoring agents which can be added to the coffee to be dispensed.

A further advantageous embodiment of the invention consists in that each of these supply means is provided with an air pump, which is connected in each case via a further line to the corresponding container, in which further line a ventilating valve is inserted in each case. With this configuration different flavoring agents can be dispensed together.

It can also be advantageous to insert a closing valve in each further line between ventilating valve and container, whereby the control can take place via this closing valve.

Another advantageous embodiment of the invention consists in that a further line comes out in each case into each container of a supply means, which further lines are each provided with a closing valve, which further lines are connected to a distribution element, from which a central line is connected to an air pump and in which central line a ventilating valve is inserted. A simplified construction can thereby be achieved for the plurality of supply means; only one air pump is necessary for the dispensing of different flavoring agents.

Advantageously, all closing valves and ventilating valves of the supply means are controllable via the control unit. In selecting coffee to be dispensed, it is thereby possible to select whether, and if applicable which, flavoring agent is to be added to the coffee.

Embodiments of the present invention will be explained more closely in the following, by way of example, with reference to the attached drawing.

Shown are:

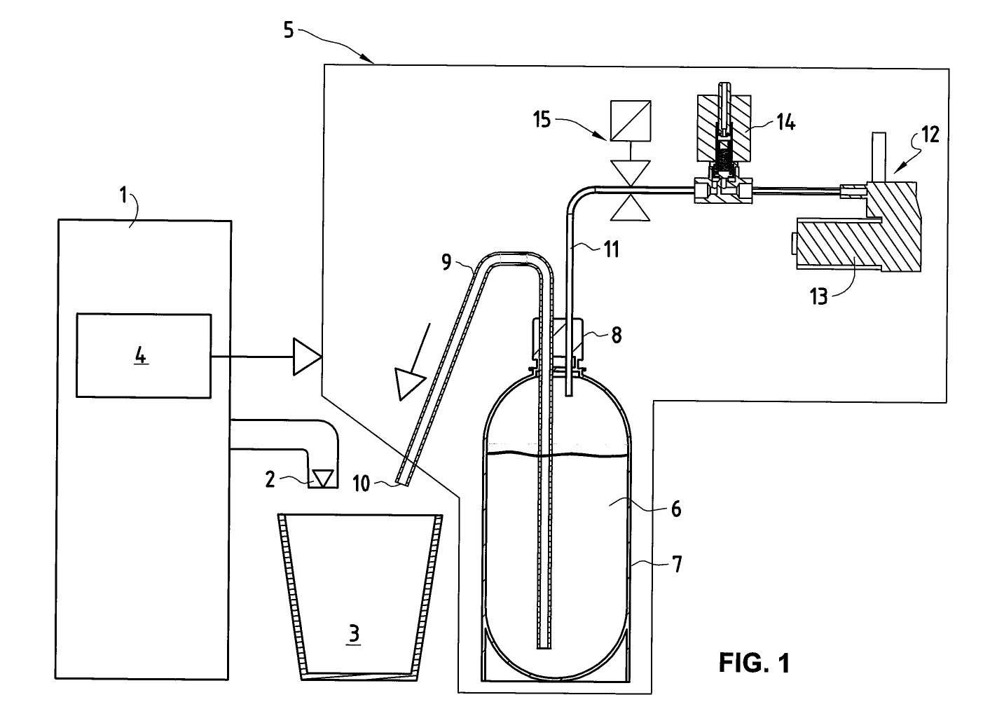

FIG. 1, in a diagrammatic representation, a coffee machine with associated supply means for adding a flavoring agent to the coffee to be dispensed;

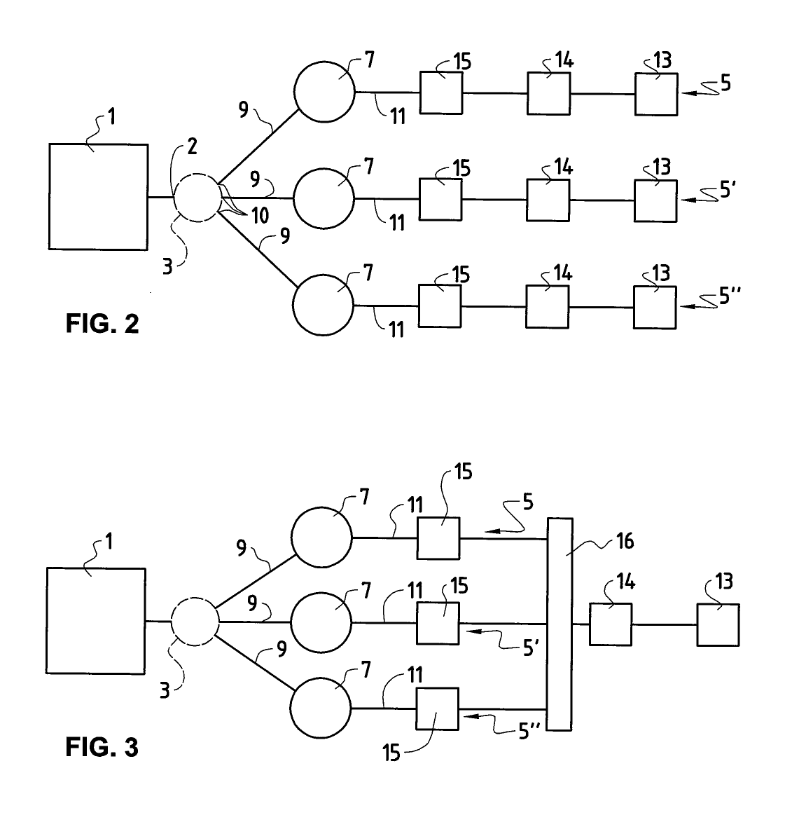

FIG. 2, in a diagrammatic representation, the configuration of a plurality of supply means for a coffee machine for dispensing of different flavoring agents; and

FIG. 3, in a diagrammatic representation, another embodiment for configuration of a plurality of supply means associated with a coffee machine.

Shown diagrammatically in FIG. 1 is a coffee machine 1. This coffee machine 1 is designed in a known way (not shown) such that coffee powder is ground in a grinder from freshly supplied coffee beans. This ground coffee powder is introduced into a brewing chamber, which is closable in a known way, and through which the water heated to the right temperature is pushed through with a predetermined pressure. Via a coffee spout 2, the thus brewed coffee ends up in a cup 3 placed under this coffee spout 2. The coffee powder residue is expelled from the brewing chamber. The coffee machine is ready to dispense another coffee.

In a known way, this coffee machine is provided with a control unit 4, which controls automatically the dispensing of a coffee. Different coffees can hereby be dispensed by selection. The selection of the respective coffee can be transmitted to the control unit by entry via push buttons, for example.

Additionally inserted in this coffee machine can be a device which can dispense milk in various forms into the cup 3, which is placed under the coffee spout 2, for example cold or warm milk as well as frothed up milk. Milk coffee or caffè latte, cappuccino, caffè macchiato, etc. can thereby be obtained from this coffee machine, in addition to normal coffee, and also espresso or ristretto.

Associated with this coffee machine 1 is a supply means 5 for supply of a flavoring agent 6 into the coffee dispensed from the coffee machine 1. This supply means 5 comprises a container 7, which has the shape of a bottle, and which is closable with a lid 8. The flavoring agent 6, which is available in a liquid, syrup-like form, can be filled into this container 7. In a known way (not shown), the level of filling of the flavoring agent 6 in this container 7 can be monitored; it can thereby be indicated to the user when the container has to be filled up again.

Inserted into the container through the lid 8 is a line 9. This line 9 is submerged into the flavoring agent 6 located in the container 7. The other end of this line 9 is provided with a spout 10. This spout 10 is disposed adjacent to the coffee spout 2, so that the flavoring agent 6 emerging from this spout 10 likewise ends up in the cup 3, which is placed under the coffee spout 2.

A further line 11 is led through the lid 8 into the interior of the container 7. This further line 11 is connected to a compressed air source 12, which is designed as an air pump 13 in the present embodiment example. Inserted into the further line is a ventilating valve 14. Inserted between ventilating valve 14 and container 7 in the further line is in addition a closing valve 15, which can be designed as peristaltic valve, for example.

This supply means is preferably integrated into the coffee machine 1. The controllable elements of this supply means 5, i.e. the air pump 13, the ventilating valve 14 and the closing valve 15, are connected to the control unit 4 of the coffee machine in a known way (not shown). To dispense a coffee, the corresponding coffee-based beverage is selected via the selection buttons, as previously described. In addition, selection buttons are provided in a known way (not shown) with which the addition of the flavoring agent to the coffee to be dispensed can be selected. With corresponding selection, the air pump 13 is activated, via the control unit 4, during the dispensing of the coffee into the cup 3. Via the further line 11, air is supplied to the container 7. By means of the resulting high pressure in the container, the flavoring agent 6 reaches the cup 3 via the line 9 and the spout 10, and is mixed with the coffee likewise flowing in. The amount of the flavoring agent 6 to be dispensed can be set. When the desired dose has been delivered, the air pump can be deactivated again. The ventilating valve is actuated. The pressure in the inner chamber of the container and in the further line 11 is reduced. The supply of flavoring agent is stopped immediately. In addition, the closing valve 15 can still be closed. The cup with the supplied coffee and the added flavoring agent can be taken away. With this apparatus, flavoring agent can be added to the coffee to be dispensed, or not, as desired. It would also be conceivable for the supplied dose quantity of flavoring agent to be likewise able to be selected, for example by selecting intensely flavored, flavored in a medium strength, or slightly flavored.

As can be seen from FIG. 2, a plurality of supply means 5, 5′, 5″ can be associated with a coffee machine 1. Each of these supply means 5, 5′, 5″ comprises a container 7, a line 9, whose outlets 10 come out into the cup 3 placed under the coffee spout 2, <and> a further line 11, each of which are <sic. is> connected to an air pump 13. Inserted into each of the further lines 11 is one ventilating valve 14 and one closing valve 15 each. Each container 7 of the respective supply means 5, 5′, 5″ can contain another flavoring agent. Different flavoring agents can thereby be additionally selected during the dispensing of coffee from the coffee machine 1, the respective supply means 5, 5′, 5″ being entered as selection via the control unit 4, whereby the desired flavoring agent is dispensed in the previously described way. In this embodiment example, three supply means 5, 5′, 5″ are represented; of course it is possible to configure another number of supply means, depending upon how big the range of selection of different flavoring agents is supposed to be.

Shown in FIG. 3 is a further embodiment possibility of how a plurality of supply means 5, 5′, 5″, which are associated with a coffee machine 1, can be designed. Each of the supply means 5, 5′, 5″ is once again provided with one container 7 each, whose lines 9 come out into the cup 3. A different flavoring agent can be accommodated in each container 7. The further lines 11 are connected to a distribution element 16, a closing valve 15 being inserted in each case between container 7 and distribution element 16. Attached to the distribution element 16 is a central line 17, which is connected to the air pump 13. Inserted between distribution element 16 and air pump 13 is a ventilating valve 14. To dispense flavoring agent, the air pump 13 is activated via the control unit, the closing valve 15, which is associated with the container 7 having the selected flavoring agent, is opened, the respective flavoring agent is dispensed. The other closing valves remain closed. As soon as the desired quantity of flavoring agent is delivered, the respective closing valve 15 is closed, the air pump 13 is deactivated. The ventilating valve 14 is opened to relieve pressure.

While several flavoring agents can be dispensed together with the embodiment as described in relation to FIG. 2, according to the embodiment as described in relation to FIG. 3, only a dispensing in series is possible. With this embodiment, however, it is possible to economize on air pumps and ventilating valves.

With the apparatus according to the invention it is possible to supplement coffee machines in such a way that an additional flavor can be given to the coffee-based beverage dispensable from these coffee machines in that supply of the respective flavoring agent can be carried out, which increases the coffee enjoyment among corresponding aficionados.

1. A coffee machine (1) for dispensing brewed coffee with a coffee spout (2), under which a vessel (3), in particular a cup, is placed, so the brewed coffee emerging through the coffee spout (2) ends up in the vessel (3), and a control unit (4), with which the operation of the coffee machine (1) and the dispensing of coffee is controllable, wherein associated with the coffee machine (1) is at least one supply means (5) for dispensing at least one flavoring agent (6), which supply means is equipped in each case with a container (7) for accommodating a flavoring agent (6) and conveying and metering means (12, 13, 14, 15) for delivering a metered quantity of the flavoring agent (6) from the container (7) into a line (9), which line (9) is provided with a spout (10) which is arranged such that the delivered flavoring agent (6) ends up in the vessel (3) positioned under the coffee spout (2).

2. The coffee machine according to claim 1, wherein the flavoring agent (6) is of liquid form and is fillable into the container (7), which is closable.

3. The coffee machine according to claim 2, wherein the conveying and metering means for each supply means (5) consist of a further line (11), which line comes out into the closable container (7), which line is connected to a compressed air source (12), and by means of which compressed air is able to be supplied to the closable container (7) in a controlled way, and the line (9) is submerged, by the end opposite the spout (10), in the liquid flavoring agent (6) filled in the container (7).

4. The coffee machine according to claim 3, wherein the compressed air source (12) consists of an air pump (13), which is able to be activated and deactivated via the control unit (4).

5. The coffee machine according to one of the claims 1 to 4, wherein a plurality of supply means (5, 5′, 5″) are associated therewith.

6. The coffee machine according to claim 5, wherein each of these supply means (5, 5′, 5″) is provided with an air pump (13) in each case, which is connected to the corresponding container (7) in each case via a further line (11), in which further line (11) a ventilating valve (14) is inserted in each case.

7. The coffee machine according to claim 6, wherein inserted into each further line (11) between ventilating valve (14) and container (7) is a closing valve (15).

8. The coffee machine according to claim 5, wherein a further line (11) comes out in each case into each container (7) of a supply means (5, 5′, 5″), which further lines (11) are each provided with a closing valve (15), which further lines (11) are connected to a distribution element (16), from which a central line (17) is connected to an air pump (13) and in which central line (17) a ventilating valve (14) is inserted.

9. The coffee machine according to claim 1, wherein all closing valves (15) and ventilating valves (14) of the supply means (5, 5′, 5″) are controllable via the control unit (4).
